(19) United States
(12) Patent Application Publication
(10) Pub. No.: US 2002/0105543 A1
(43) Pub. Date: Aug. 8, 2002

(54) User interface management for controlled devices

(76) Inventors: Sheng Dong, Fremont, CA (US); Qiaoyun Li, Cupertino, CA (US); Ling Liu, Milpitas, CA (US)

Correspondence Address: Maria McCormack Sobrino, BLAKELY, SOKOLOFF, TAYLOR & ZAFMAN LLP, 7th Floor, 12400 Wilshire Boulevard, Los Angeles, CA, 90025, US

(21) Appl. No.: 09/779,046

(22) Filed: Feb. 7, 2001

(51) Int. Cl. G06F 13/00

(52) U.S. Cl. 345/744; 345/740

(57) ABSTRACT

In one embodiment, the present invention determines an identification corresponding to a device and a user interface corresponding to the identification of the device is remotely loaded from a remote source. In another embodiment, a user interface corresponding to the identification of the device is locally loaded from a local source. In yet another embodiment, a basic user interface corresponding to the identification of the device is loaded if a user interface corresponding to the identification of the device is not found by searching remotely or locally.

### FIELD OF THE INVENTION

The present invention relates to controlled electronics devices. Specifically, the present invention relates to user interface management for controlled devices.

### ART BACKGROUND

Consumer electronics devices are often set up such that a home gateway interfaces a plurality of consumer electronics devices through a communication medium. Some examples include a television set (TV) interfacing a video cassette recorder (VCR), a personal computer (PC) interfacing a minidisk drive (MD), and a set top box (STB) interfacing the cable company audio/video lines.

The consumer electronics industry is always searching for faster, easier communication media to transfer video, audio and other information among the devices. Lately, the industry has taken a liking to the communication media defined under the IEEE 1394 protocol. Manufacturers are increasingly offering consumer electronics products that are compatible with the IEEE 1394 defined communication channels.

IEEE 1394 is a standard for high-speed serial connections approved by the Institute of Electrical and Electronics Engineers in 1995. The standard is designed for easy-to-use, low-cost and high-speed exchange of information among the consumer electronics devices that transfer large amounts of data. IEEE 1394 supports transfer rates of 100, 200 and 400 Mbps.

IEEE 1394 is valuable also because it supports both asynchronous and isochronous (real-time) data transfers. The devices that can communicate via the IEEE 1394 compatible media are referred to as IEEE 1394 compatible devices or simply as 1394 devices.

Typically, for 1394 as well as non-1394 devices, the user controls the operation of the device by using the user interface such as a control panel provided by that individual device. For example, the user uses the “play”, “stop”, “rewind”, and “fast forward” control buttons on the VCR itself to control the operation of the VCR. Similarly, the user uses the control buttons on the TV such as the “power”, “volume”, and channel select buttons to control the operation of the TV to which the VCR is connected.

By using the attributes associated with the 1394 devices, the control of their operation can be made more flexible and easier. This will increase the popularity of the 1394 devices and the consumer electronics devices in general.

### SUMMARY OF THE INVENTION

In one embodiment, the present invention determines an identification corresponding to a device and a user interface corresponding to the identification of the device is remotely loaded from a remote source. In another embodiment, a user interface corresponding to the identification of the device is locally loaded from a local source. In yet another embodiment, a basic user interface corresponding to the identification of the device is loaded if a user interface corresponding to the identification of the device is not found by searching remotely or locally.

### BRIEF DESCRIPTION OF THE DRAWINGS

The present invention is illustrated by way of example and not limitation in the figures of the accompanying drawings, in which like references indicate similar elements, and in which:

FIG. 1 illustrates one embodiment of the system of the present invention.

FIG. 2 illustrates another embodiment of the system of the present invention.

FIG. 3 illustrates a flow chart of one embodiment of the method of the present invention.

### DETAILED DESCRIPTION

The system and method of the present invention disclose a user interface loader (UIL) for electronics devices that are controlled across a communication medium such as a bus or a network. The UIL provides the controller with a user interface corresponding to an electronics device to control the operation of the electronics device through the communication medium.

In this description, a UIL for 1394 compatible consumer electronics devices is disclosed by way of example. It will be evident, however, that with various modifications and changes that do not depart from the broader spirit and scope of the present invention, the present invention can relate to non-consumer devices and non-1394 compatible consumer devices as well.

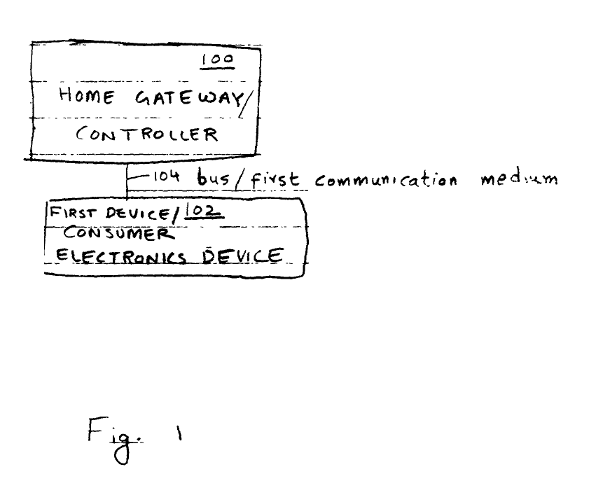

FIG. 1 illustrates one embodiment of the system of the present invention. A consumer electronics device set up is shown including a home gateway 100, which functions as a controller device to interface and control a consumer electronics device (“the first device”) 102 via a first communication medium 104. In this description, the terminology “home gateway” and “controller” is used interchangeably. The controller 100 can be a television set (TV), a personal computer (PC), a set top box (STB), and the like. The first device 102 can be a videocassette recorder (VCR), a minidisk drive (MD), a cable company audio/video line, and the like.

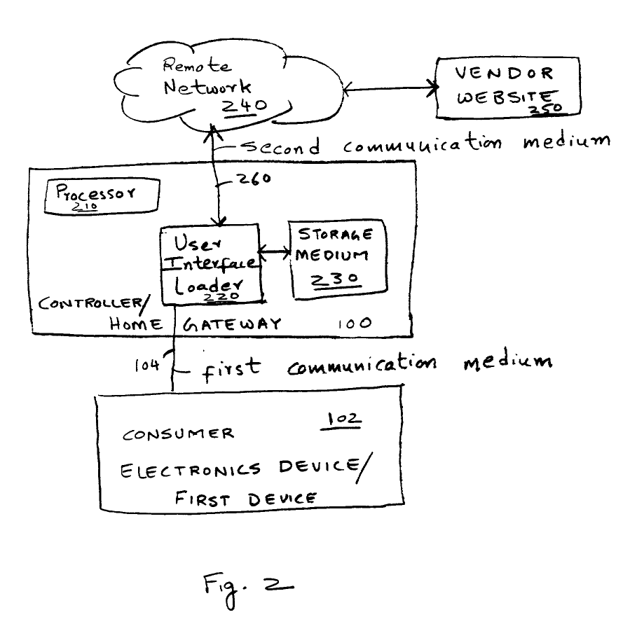

In one embodiment, for example, the controller 100 is the TV and the first device 102 is the VCR. In this embodiment, the TV 100 includes a user interface corresponding to the VCR 102 through which the user can control the operation of the VCR 102; the UIL provides the TV with the user interface. The UIL is discussed in detail with reference to FIG. 2.

In one embodiment, a network includes multiple controllers 100 and first devices 102. For one example, a network includes a first PC, a second PC and a MD. The first PC controls the operation of the MD and the second PC controls the operation of the first PC. The first PC is thus both a controller 100 and a first device 102. For another example, a network includes a PC, a TV and a STB. The PC controls the operation of the STB as well as the operation of the TV. This network can be used, for example, to block certain TV channels.

FIG. 2 illustrates another embodiment of the system of the present invention. The User Interface Loader (UIL) 220 is shown housed inside the controller 100. It is contemplated that the UIL 220 can be situated outside the controller 100. The UIL 220 interfaces the first device 102, the controller storage medium 230 and the remote network 240. In one embodiment, the controller storage medium 230 includes physical memory devices such as electronics chips capable of holding data and virtual memory devices. In another embodiment, the controller storage medium 230 includes storage devices such as disks and tape drives. In yet another embodiment, the controller storage medium 230 is a combination of memory and storage devices.

The UIL 220 is configured to receive the identification information regarding the first device 102. For an embodiment that operates on a 1394 network and a first device 102 that is 1394 compatible, the identification information can include the global unique identifier (GUID) or the unit information (UINFO). The GUID is a unique 88-bits serial number embedded in the first device 102 that is the fingerprint of the first device 102. The GUID identifies device characteristics such as device category, vendor name and model. For example, the GUID of the first device 102 can identify it as a VCR (category), SONY (vendor) and SLV-M11 HF (model). Each 1394 device is equipped with a GUID. The UINFO identifies the device category, for example, as a VCR, TV, STB, or the like. Unlike the GUID, the UINFO does not identify the vendor name or the model of the first device 102. Like the GUID, a UINFO is embedded in each 1394 device. In alternate embodiments, other forms of identification may be used.

The UIL 220 is configured to search the controller storage medium 230 and the remote network 240 for a user interface corresponding to the identification information. In this description, the controller storage medium 230 and the remote network 240 are also referred to as local and non-local networks respectively. If such a user interface is found, the UIL 220 is configured to load the user interface on the controller 100. The user can control the operation of the first device 102 through this user interface. The UIL 220 is configured to ensure that this user interface has the same operational impact on the first device 102 as, for example, the control buttons provided by the first device 102. To achieve this, in one embodiment, if the first device 102 and the controller 100 are 1394 compatible, the UIL 220 uses the Audio Video Commands Digital Interface Command Set (AV/C set) to control the operation of the consumer electronics device 102 through the controller 100.

The AV/C set is defined under the IEEE 1394 standard. The transport of AV/C set commands from the UIL 220 to the first device 102, and the transport of return responses to the commands from the first device 102 to the UIL 220, is done via the 1394 bus 104. The AV/C set commands and responses are transported by the Function Control Protocol (FCP) defined by the International Electrotechnical Commission (IEC)—1883, proposed standard for Digital Interface for Consumer Electronic Audio/Video equipment. The AV/C set commands and responses are encapsulated within FCP frames and transmitted between the FCP_COMMAND and FCP_RESPONSE registers of the UIL 220 and the first device 102. An AV/C set command transmitted by the UIL 220 and the associated response(s) returned by the first device 102 comprise an AV/C transaction.

The types of commands comprising the AV/C set include control, status, inquiry, and notify. The control command is sent by the UIL 220 to the first device 102 to instruct the device 102 to perform an operation. For example, in one embodiment, the PLAY control command is used to request a VCR 102 transport mechanism to playback data previously recorded on the medium. A few examples of the responses comprising the AV/C set include accepted, rejected, and in transition. A response of “accepted” to the UIL 220 FCP_RESPONSE register, referring to the previous example, would indicate to the UIL 220 that the PLAY command was executed.

In one embodiment, the system of FIG. 2 includes two communication media. The first communication medium 104 interfaces the controller 100 with the first device 102. In one embodiment, the first communication medium 104 is a 1394 compatible bus. In alternate embodiments, the communication medium can be wired, wireless, optical and the like. The second communication medium 260 interfaces the controller 100 with the remote network 240. In one embodiment, the remote network 240 includes an information network.

In one embodiment, the information network includes the Internet with access to the World Wide Web. In one embodiment, the UIL 220 includes a search engine configured to search for the user interfaces corresponding to the GUID or the UINFO on the World Wide Web. In one embodiment, the search engine sends out a spider to fetch the user interfaces. In one embodiment, the UIL 220 includes an indexer configured to list the user interfaces fetched by the spider. In one embodiment, the UIL 220 is configured to download to the controller 100 the user interface selected by the user from the list of the user interfaces from its location on the World Wide Web.

In an alternate embodiment, the information network includes a private information network such as a private database including non-World Wide Web information. In one embodiment, the second communication medium 260 is a 1394 compatible bus. This can be the same bus that the device 102 is coupled to or a separate bus. In alternate embodiments, the second communication medium 260 can be wired, wireless, optical and the like.

In one embodiment, the UIL 220 can be configured to provide the user with the ability to customize the user interface. In one embodiment, for example, the UIL 220 loads a library of customizing tools on the controller 100 such that the user can add or remove the control buttons to the user interface. For example, the user can add to the VCR user interface the “power on” and “power off” control buttons and remove from the VCR user interface the “record” control button. In this case, by removing the “record” control button, the user has eliminated the possibility of using the VCR transport mechanism to record signals on the videocassette present in the VCR.

In one embodiment, the UIL 220 is configured to initiate a program that provides the user with a basic user interface corresponding to the first device 102. In one embodiment, the basic user interface is a basic control template corresponding to the first device 102 category, for example, a VCR, MD, and the like. The UIL 220 is configured to initiate the program dynamically or through user interaction.

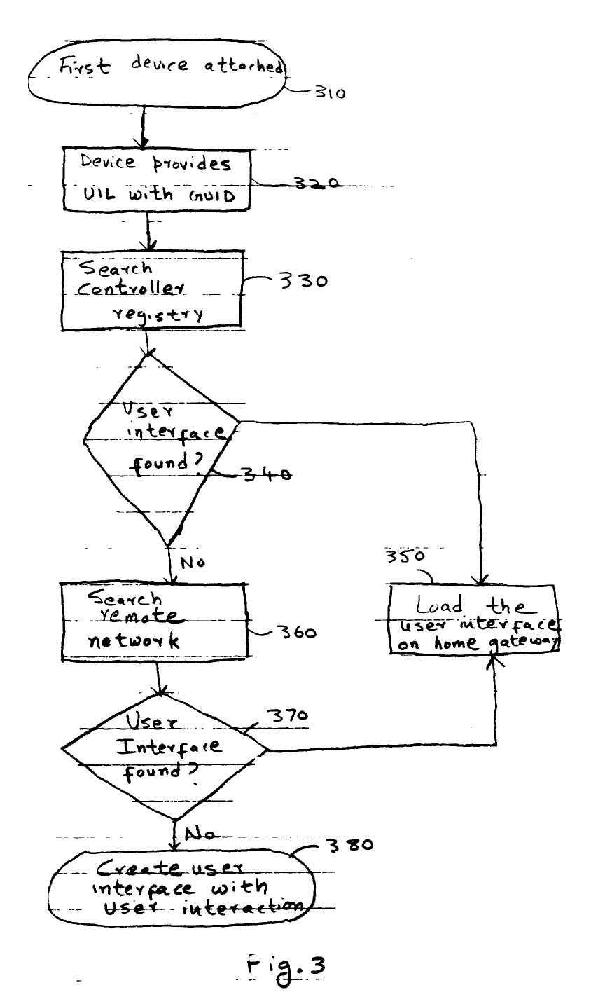

FIG. 3 illustrates one embodiment of the method for loading a user interface. In one embodiment, the steps shown in the flow diagram are implemented in the systems of FIG. 1 and FIG. 2. The method is illustrated by way of example wherein the controller and the device are 1394 compatible.

At step 310, the first communication medium is automatically reset and reconfigured because a new consumer electronics device is attached to the first communication medium. The IEEE 1394 is a peer-to-peer protocol and the UIL receives an indication that a new device (“the first device”) has been coupled to the network.

In one embodiment, the first device provides the UIL with its Global Unique Identifier (GUID) (at step 320). In another embodiment, the first device provides the UIL with its unit information (UINFO).

When the UIL receives the GUID, it searches the controller registry to find a user interface corresponding to the GUID (at step 330). The registry is a table located in the storage medium of the controller that contains a list of GUIDs and their corresponding user interfaces respectively. If a GUID and its corresponding user interface are found in the registry (at step 340), the UIL loads the user interface on the controller (at step 350). The loaded user interface corresponds to the first device. More particularly, the user can control the operation of the first device from the controller through this user interface. For example, if the first device is a SONY VCR model SLV-M11 HF, a user interface similar to the one on the actual SONY VCR model SLV-M11 HF is loaded on the controller. In one embodiment, the control buttons such as “play”, “stop”, “rewind”, “fast forward”, and “record” are situated similarly on the two user interfaces. For example, the user interface is loaded on a TV (controller) to which a VCR (the first device) is connected such that the user can control the operation of the VCR through the TV. This is a key advantage of present invention because it offers the user more flexibility in the operation of the consumer electronics devices.

In one embodiment, the user has the option (at step 310) to skip the registry search and proceed instead to create his/her own user interface. The methodology for the user to create his/her own user interface is described below with reference to step 380.

In another embodiment, when the UIL receives the UINFO (at step 320), the UIL automatically loads on the controller a basic user interface corresponding to the first device category identified by the UINFO. The UINFO can categorize the first device as, for example, a VCR or a MD. The UIL initiates a program to provide a basic user interface corresponding to the device category identified by the UINFO. For example, the basic user interface for the VCR device category can include the “play”, “stop”, “rewind”, “fast forward”, and “record” control buttons. In one embodiment, the program is the Wizard™ program provided by the Microsoft Corporation. In one embodiment, the user can add or remove control buttons by using the library of customizing tools.

If no user interface corresponding to the GUID is found in the registry, the UIL searches a remote network across a communication medium (at step 360). The communication medium can be the first communication medium or another communication medium coupled to the controller. In one embodiment, the communication medium is a second communication medium that interfaces the controller to the Internet with access to the World Wide Web. In this embodiment, the UIL uses the vendor name and model information extracted from the GUID to search the vendor's Web Site for a user interface corresponding to the GUID. For example, the Web Site can be www.sony.com with a hot link to a user interface corresponding to, for example, the Sony VCR model SLV-M11 HF. If a user interface corresponding to the GUID is found (at step 370), then the user interface is loaded on the controller (at step 350).

In one embodiment, the second communication medium does not interface to a remote network such as the Internet. In this case, if no user interface corresponding to the GUID is found in the registry, then the UIL skips the search across the second communication medium (at step 360) and offers the user the option to create a user interface with user interaction (at step 380).

If no user interface corresponding to the GUID is found in the registry (at step 330) or during the search across the second communication medium (at step 360), the user can create his/her own user interface. At step 380, the UIL offers the user the option to create a user interface to be loaded on the controller to control the operation of the first device. In one embodiment, the UIL prompts the user to categorize the type of the first device. The user can categorize the first device as, for example, a VCR or a MD. In an alternate embodiment, the UIL extracts this information from the GUID. The UIL initiates a program to provide a basic user interface corresponding to the device category identified by the user or the GUID. For example, the basic user interface for the VCR device category can include the “play”, “stop”, “rewind”, “fast forward”, and “record” control buttons. In one embodiment, the program is the Wizard™ program provided by the Microsoft Corporation. In one embodiment, the user can add or remove control buttons by using the library of customizing tools.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

In addition, the methods as described above can be stored in memory of a computer system as a set of instructions to be executed. In addition, the instructions to perform the methods as described above could alternatively be stored on other forms of computer-readable mediums, including magnetic and optical disks. For example, the method of the present invention can be stored on computer-readable mediums, such as magnetic disks or optical disks that are accessible via a disk drive (or computer-readable medium drive).

These and other embodiments of the present invention may be realized in accordance with these teachings and it should be evident that various modifications and changes may be made in these teachings without departing from the broader spirit and scope of the invention. The specification and drawings are, accordingly, to be regarded in an illustrative rather than restrictive sense and the invention measured only in terms of the claims.

What is claimed is:

1. A method comprising:
determining an identification corresponding to a device; and
remotely loading a user interface from a remote source wherein the user interface corresponds to the identification of the device.

2. The method of claim 1, wherein the identification is selected from the group consisting of global unique identification (GUID) and unit information (UINFO).

3. The method of claim 1, further comprising:
remotely searching for a user interface corresponding to the identification.

4. The method of claim 1, wherein the remote source includes the World Wide Web.

5. The method of claim 1, further comprising:
remotely loading a user interface corresponding to the identification if a user interface corresponding to the identification is not found by searching locally.

6. The method of claim 5, wherein locally searching includes searching the storage medium of a controller.

7. The method of claim 3, further comprising:
loading a basic user interface if a user interface corresponding to the identification is not found by searching remotely.

8. The method of claim 7, wherein the basic user interface can be modified through an user input.

9. The method of claim 1, wherein the user interface is loaded on a controller.

10. The method of claim 1, wherein the user interface controls the device operation.

11. A method comprising:
determining an identification corresponding to a device;
loading a particular user interface wherein the particular user interface corresponds to the identification of the device; and
loading a basic user interface if the particular user interface is not found.

12. The method of claim 11, wherein the identification is selected from the group consisting of global unique identification (GUID) and unit information (UINFO).

13. The method of claim 11, further comprising:
locally searching for a particular user interface; and
remotely searching for a particular user interface if a particular user interface is not found by searching locally.

14. The method of claim 13, wherein locally searching includes searching a storage medium of a controller.

15. The method of claim 13, wherein remotely searching includes searching the World Wide Web.

16. The method of claim 11, wherein the basic user interface can be modified through user input.

17. The method of claim 11, wherein the user interface is loaded on a controller.

18. The method of claim 11, wherein the user interface controls the device operation.

19. A device controller comprising:
a processor; and
the device controller configured to detect the coupling of a device to a first communication medium, to load a user interface that corresponds to an identification received from the device on the device controller, and to load a basic user interface on the device controller if a user interface that corresponds to the identification is not found.

20. The device controller of claim 19, further comprising:
the device controller is configured to search for a user interface corresponding to the identification at the locations selected from the group consisting of a storage medium coupled to the processor and a remote network.

21. The device controller of claim 20, further comprising:
the device controller is configured to search the remote network if a user interface corresponding to the identification is not found by searching the storage medium coupled to the processor.

22. The device controller of claim 19, wherein the first communication medium is an IEEE 1394 protocol compliant.

23. The device controller of claim 20, wherein searching the remote network includes searching across the first communication medium.

24. The device controller of claim 23, wherein the first communication medium is the World Wide Web.

25. The device controller of claim 20, wherein the storage medium is selected from the group consisting of memory and storage devices.

26. The device controller of claim 19, wherein the identification is selected from the group consisting of global unique identification (GUID) and unit information (UINFO).

27. The device controller of claim 19, further comprising a library of customizing tools for a user to modify the basic user interface prior to the loading on the device controller.

28. The device controller of claim 19, further comprising the device controller controls the device operation through the user interface.

29. A computer-readable medium having stored thereon a set of instructions to translate instructions, the set instructions, which when executed by a processor, cause the processor to perform a method comprising:
determining an identification corresponding to a device; and
remotely loading a user interface from a remote source wherein the user interface corresponds to the identification of device.

30. The computer-readable medium of claim 29, wherein the identification is selected from the group consisting of global unique identification (GUID) or unit information (UINFO).

31. The computer-readable medium of claim 29, further comprising:
remotely searching for a user interface corresponding to the identification.

32. The computer-readable medium of claim 29, wherein the remote source includes the World Wide Web.

33. The computer-readable medium of claim 29, further comprising:
remotely loading a user interface corresponding to the identification if a user interface corresponding to the identification is not found by searching locally.

34. The computer-readable medium of claim 33, wherein locally searching includes searching the storage medium of a controller.

35. The computer readable medium of claim 31, further comprising:
loading a basic user interface if a user interface corresponding to the identification is not found by searching remotely.

36. The computer readable medium of claim 35, wherein the basic user interface can be modified through an user input.

37. The computer readable medium of claim 29, wherein the user interface is loaded on a controller.

38. The computer readable medium of claim 29, wherein the user interface controls the device operation.
